(19) United States
(12) Patent Application Publication
(10) Pub. No.: US 2026/0082136 A1
(43) Pub. Date: Mar. 19, 2026

(54) IMAGING SYSTEM FOR CAPTURING IMAGES FROM VEHICLES OF VARIOUS SIZES

(71) Applicant: BWI Acquisition, Inc., Chesterfield, MO (US)

(72) Inventors: Darren R. Kemper, Chesterfield, MO (US); Christopher L. Dillow, Chesterfield, MO (US); Gabriela A. Turner, Chesterfield, MO (US); James M. Commons, Chesterfield, MO (US)

(21) Appl. No.: 19/323,337

(22) Filed: Sep. 9, 2025

Related U.S. Application Data
(60) Provisional application No. 63/692,495, filed on Sep. 9, 2024.

(51) Int. Cl. H04N 23/90; H04N 23/54; H04N 23/695

(52) U.S. Cl. CPC H04N 23/90; H04N 23/54; H04N 23/695

(57) ABSTRACT

An imaging system for imaging vehicles of different sizes includes a plurality of cameras and a processor. The plurality of cameras are located above and/or to the side of a vehicle. Each of the plurality of cameras are in a spaced apart relationship relative to adjacent ones of the plurality of cameras. The processor is communicatively coupled to the plurality of cameras and configured to control which of the plurality of cameras acquire image data of the vehicle, wherein, in response to a first vehicle of a first size being located below the plurality of cameras, the processor acquires image data of the first vehicle from a first set of the plurality of cameras, and in response to a second vehicle of a second size being located below the plurality of cameras, the processor acquires image data of the second vehicle from a second set of the plurality of cameras.

### CROSS-REFERENCE TO RELATED APPLICATIONS

This application claims the benefit of U.S. Provisional Patent Application No. 63/692,495 , filed Sep. 9, 2024, the entire disclosure of which is herein incorporated by reference for all purposes.

### TECHNICAL FIELD

This disclosure relates generally to imaging systems for vehicles of various sizes.

### BACKGROUND

Consumers usually make purchases in one of two ways. One traditional approach, involves visiting a dealer or merchant's place of business, listening to a salesperson's pitch, testing selected goods, and then haggling over price. This approach advantageously provides consumers an opportunity to view the particular product and receive hands-on demonstrations of features and options or the ability to view it in its entirety. However, this approach is time-consuming and interacting with a salesperson can be intimidating for many consumers.

With regard to vehicles, such as cars, consumers can conduct on-line shopping for cars whereby images of a car and pertinent information regarding the car can be reviewed by the consumer and compared against other vehicles. However, quickly obtaining high quality photos of vehicles can be difficult. The difficulty of obtaining high quality photos of vehicles is exacerbated when the vehicles to be imaged are of various sizes. For example, some vehicles can be more than triple the size of other vehicles, requiring time-consuming selection and movement of cameras. Additionally, imaging vehicles of various sizes for damage detection purposes is even more difficult since image quality, and proximity of the cameras to the vehicle, is even more important. Therefore, improved systems and methods of acquiring photographs and/or videos of cars and other vehicles (or other items) are needed. Improved systems and methods of imaging vehicles of various sizes is also needed. Additionally, imaging systems and methods for detecting damage on vehicles (or other items) that are capable of quickly and efficiently adapting to the needs of imaging vehicles of various sizes are needed. All these and other objects of the present invention will be understood through the detailed description of the invention below.

### SUMMARY

In one embodiment, an imaging system for imaging vehicles of different sizes includes a plurality of cameras and a processor. The plurality of cameras are located around a vehicle. Each of the plurality of cameras are in a spaced apart relationship relative to adjacent ones of the plurality of cameras. The processor is communicatively coupled to the plurality of cameras and is configured to control which of the plurality of cameras acquire image data of the vehicle. In response to a first vehicle of a first size being located below the plurality of cameras, the processor acquires first image data of the first vehicle from a first set of the plurality of cameras. In response to a second vehicle of a second size being located below the plurality of cameras, the processor acquires second image data of the second vehicle from a second set of the plurality of cameras. The first size is different from the second size and the first set of the plurality of cameras is different from the second set of the plurality of cameras.

In another embodiment, a method of imaging vehicles includes moving a first vehicle relative to a plurality of cameras. The plurality of cameras are arranged in a spaced-apart relationship and are part of an imaging system. The imaging system also includes a processor communicatively coupled to the plurality of cameras and configured to control which of the plurality of cameras acquire image data. The method further includes acquiring, via at least one of the plurality of cameras, first initial image data of the first vehicle. The method also includes determining, via the processor, a first size of the first vehicle based on the first initial image data of the first vehicle; and capturing first image data of the first vehicle via a first set of the plurality of cameras. The first set of the plurality of cameras is based on the first size of the first vehicle. The method also includes moving a second vehicle relative to the plurality of cameras after the first vehicle has moved away from the plurality of cameras; and acquiring, via at least one of the plurality of cameras, second initial image data of the second vehicle. The method further includes determining, via the processor, a second size of the second vehicle based on the second initial image data of the second vehicle; and capturing second image data of the second vehicle via a second set of the plurality of cameras. The second set of the plurality of cameras is based on the second size of the second vehicle. The first size is different from the second size and the first set of the plurality of cameras is different from the second set of the plurality of cameras.

In yet another embodiment, a method of imaging vehicles includes moving a first vehicle relative to a plurality of cameras. The plurality of cameras are arranged in a spaced-apart relationship and are included in an imaging system. The imaging system also includes a processor communicatively coupled to the plurality of cameras and configured to control which of the plurality of cameras acquire image data. The method further includes receiving, via the processor, a first size of the first vehicle from a user; and capturing first image data of the first vehicle via a first set of the plurality of cameras. The first set of the plurality of cameras is based on the first size of the first vehicle. The method also includes, after the first vehicle has moved away from the plurality of cameras, moving a second vehicle relative to the plurality of cameras. The method further includes receiving, via the processor, a second size of the second vehicle from the user; and capturing second image data of the second vehicle via a second set of the plurality of cameras. The second set of the plurality of cameras is based on the second size of the second vehicle. The first size is different from the second size and the first set of the plurality of cameras is different from the second set of the plurality of cameras.

In another embodiment, an imaging system for imaging vehicles of different sizes includes a plurality of cameras and a processor. The plurality of cameras are located above and/or to the side of a vehicle. Each of the plurality of cameras are in a spaced apart relationship relative to adjacent ones of the plurality of cameras. The processor is communicatively coupled to the plurality of cameras and is configured to control which of the plurality of cameras acquire image data of the vehicle, wherein, in response to a first vehicle of a first size being located below the plurality of cameras, the processor acquires image data of the first vehicle from a first set of the plurality of cameras, and wherein, in response to a second vehicle of a second size being located below the plurality of cameras, the processor acquires image data of the second vehicle from a second set of the plurality of cameras. The first size is different from the second size, and the second set of the plurality of cameras is different from the first set of the plurality of cameras.

In another embodiment, a method of imaging vehicles with an imaging system having a plurality of cameras arranged in a spaced-apart relationship and a processor communicatively coupled to the plurality of cameras and configured to control which of the plurality of cameras acquire image data of the vehicle, includes acquiring, via at least one of the plurality of cameras, initial image data of the vehicle; determining, via the processor, a size of the vehicle based on the initial image data of the vehicle; and capturing image data of the vehicle via a predetermined set of the plurality of cameras. The predetermined set of the plurality of cameras is based on the size of the vehicle, wherein in response to a first vehicle of a first size being located below the plurality of cameras, the processor acquires image data of the first vehicle from a first set of the plurality of cameras, and wherein, in response to a second vehicle of a second size being located below the plurality of cameras, the processor acquires image data of the second vehicle from a second set of the plurality of cameras. The first size is different from the second size. The second set of the plurality of cameras is different from the first set of the plurality of cameras.

In another embodiment, a method of imaging vehicles with an imaging system having a plurality of cameras arranged in a spaced-apart relationship and a processor communicatively coupled to the plurality of cameras and configured to control which of the plurality of cameras acquire image data of the vehicle, includes moving the vehicle relative to the plurality of cameras; receiving, via the processor, a size of the vehicle from a user; and capturing image data of the vehicle via a predetermined set of the plurality of cameras. The predetermined set of the plurality of cameras is based on the size of the vehicle, wherein, in response to a first vehicle of a first size being located below the plurality of cameras, the processor acquires image data of the first vehicle from a first set of the plurality of cameras, and wherein, in response to a second vehicle of a second size being located below the plurality of cameras, the processor acquires image data of the second vehicle from a second set of the plurality of cameras. The first size is different from the second size. The second set of the plurality of cameras is different from the first set of the plurality of cameras.

In yet another embodiment, an imaging system for a vehicle includes a plurality of rods, a plurality of cameras, and a processor. The plurality of rods extend downwardly from a structure located above the vehicle. Each of the plurality of rods is arranged in a spaced-apart relationship relative to adjacent ones of the plurality of rods. Each of the plurality of cameras is coupled to a corresponding one of the plurality of rods. The processor is communicatively coupled to the plurality of cameras and configured to control which of the plurality of cameras acquire image data of the vehicle, wherein, in response to a first vehicle of a first size being located below the plurality of cameras, the processor acquires image data of the first vehicle from a first set of the plurality of cameras, and wherein, in response to a second vehicle of a second size being located below the plurality of cameras, the processor acquires image data of the second vehicle from a second set of the plurality of cameras. The first size is different from the second size. The second set of the plurality of cameras is different from the first set of the plurality of cameras.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

Disclosed herein are embodiments of systems, apparatuses, and methods pertaining to an imaging system for capturing images of vehicles of various sizes. This description includes drawings, wherein:

FIG. 1 is an imaging system for imaging vehicles of different sizes, according to one embodiment.

FIG. 2 is an imaging system for imaging vehicles of different sizes, according to another embodiment.

FIG. 3 is a process flow diagram of a method of imaging vehicles of different sizes.

While the invention is susceptible to various modifications and alternative forms, specific embodiments will be shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

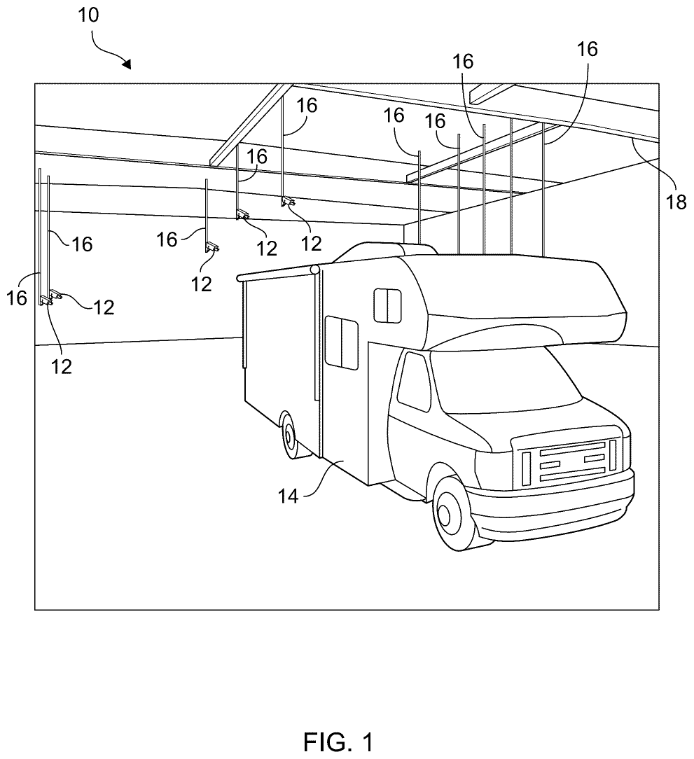

FIG. 1 shows an imaging system 10 for imaging vehicles of different sizes, according to one embodiment. The imaging system 10 includes a plurality of cameras 12 that are arranged above and around a vehicle 14 to be imaged. The vehicle 14 may be a trailer, a motorhome, a boat, a car, a truck, a motorcycle, or any other vehicle for which imaging is desired. Each of the plurality of cameras 12 is attached to a rod 16 that extends downwardly from a structure 18 located above the vehicle 14, such as structures associated with the ceiling of the facility. However, this is not required, and in some embodiments, some or all of the rods 16 extend from walls and/or a floor of the structure 18. The cameras 12 are spaced apart from each other and are positioned around the vehicle 14 to capture images of the vehicle 14 from a variety of different angles. In some embodiments, some or all of the cameras 12 are capable of panning, tilting, and/or zooming. Additionally, and in some embodiments, some or all of the rods 16 are bendable or movable to properly locate the cameras 12 relative to the vehicle 14.

A processor (not shown) is communicatively coupled to the cameras 12. The processor controls which of the cameras 12 acquires image data of the vehicle 14. For example, the processor controls the number of cameras 12 that acquire image data and the locations of cameras 12 that acquire image data. The processor determines which set of cameras 12 acquires image data of the vehicle 14 based on the size of the vehicle 14. For example, smaller vehicles are imaged with fewer cameras 12 and/or only cameras 12 within a certain distance of the vehicle 14. As another example, a greater number of cameras 12 acquire image data of larger vehicles, such as the large recreational vehicle 14 shown in FIG. 1.

The processor receives a size of the vehicle 14 automatically or manually. In embodiments in which the processor receives a size of the vehicle 14 manually, a user inputs a size of the vehicle 14 to the processor through a display device, smartphone device, and/or software application communicatively coupled to the processor, or through any other suitable means. In embodiments in which the processor receives a size of the vehicle 14 automatically, one or more of the cameras 12 acquires initial image data of the vehicle 14. Based on this initial image data, the processor determines a size of the vehicle 14. The size of the vehicle 14 includes a length, a width, a height, and/or a number of tires of the vehicle 14.

In response to the processor receiving a size of the vehicle 14 (automatically or manually), the processor then acquires image data of the vehicle 14 from a pre-selected set of cameras 12. There are different pre-selected sets of cameras 12 for different sizes of the vehicle 14. In some embodiments, there are different pre-selected sets of cameras 12 for different pre-selected size ranges of vehicles 14. As one example, there are different pre-selected sets of cameras 12 for vehicles 14 with lengths in the pre-selected ranges of less than 10 feet, between 10 and 14 feet, between 14 and 16 feet, between 16 and 18 feet, and greater than 18 feet. A user may define the predetermined ranges by inputting the predetermined ranges to the processor.

The imaging system 10 may have any suitable number of cameras 12. For example, an imaging system 10 installed in a bass-boat manufacturing facility intended to capture image data of bass boats may be smaller and include fewer cameras 12 than an imaging system 10 installed in recreational vehicle facility. In some embodiments, the imaging system 10 includes at least one camera 12, at least two cameras 12, at least five cameras 12, at least ten cameras 12, at least fifteen cameras 12, and/or at least seventeen cameras 12.

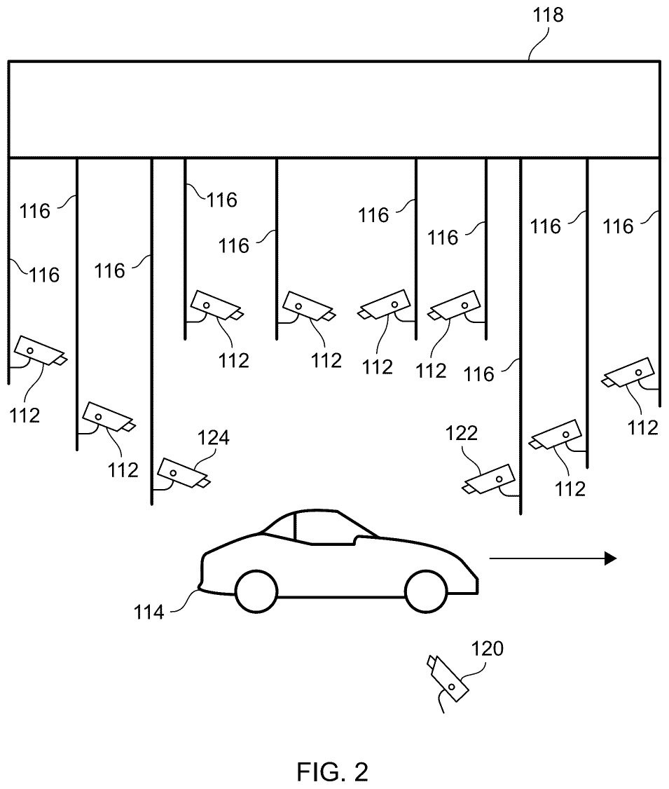

FIG. 2 illustrates an alternative configuration for an imaging system 110 for imaging vehicles 114 of different sizes, relative to the imaging system 10 of FIG. 1. In FIG. 2, the reference numerals are listed as 100-series reference numerals that represent structures and features that are similar to the structures and features of the imaging system 10 of FIG. 1 that have two-digit reference numerals. The imaging system 110 includes cameras 112 attached to rods 116 that extend from a structure 118 located above the vehicle 114. Unlike the imaging system 10 of FIG. 1, the imaging system 110 of FIG. 2 also includes a lower camera 120 that is capable of capturing image data of an undercarriage of the vehicle 114.

Additionally, the imaging system 110 of FIG. 2 includes a movable front camera 122 and a movable rear camera 124. The movable front camera 122 is capable of moving closer to and/or further away from a front of the vehicle 114. For example, the movable front camera 122 moves closer to a front of smaller vehicles 114 and moves further back when imaging larger vehicles 114. Similarly, the movable rear camera 124 is capable of moving closer to and/or further away from a rear of the vehicle 114. In some embodiments, the movable front camera 122 and/or the movable rear camera 124 are capable of panning, tilting, and/or zooming. For example, the movable front camera 122 and/or the movable rear camera 124 are capable of zooming in on the front and/or back license plates of the vehicle 114 to capture image data of the vehicle's 114 license plate(s).

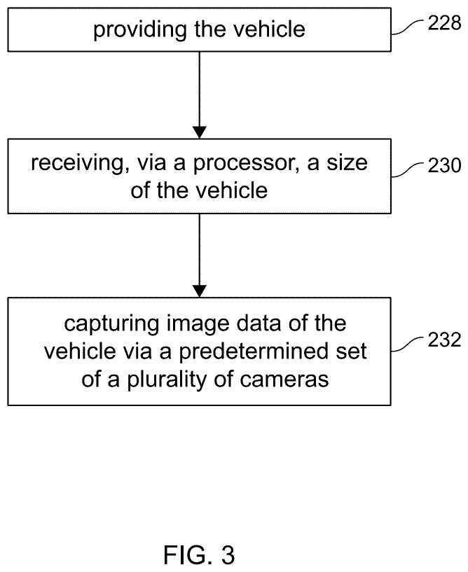

FIG. 3 shows a process flow diagram of a method of imaging vehicles of different sizes with an imaging system. The imaging system may be, for example, one of the imaging systems 10, 110 described herein. In block 228, a vehicle is provided. The vehicle may be any of the vehicles 14, 114 described herein. In block 230, a processor receives a size of the vehicle. The processor may be any of the processors described herein as a component of the imaging system 10, 110. The processor may receive a size of the vehicle automatically or manually, as described herein. In block 232, image data of the vehicle is captured via a predetermined set of a plurality of cameras. The predetermined set of the plurality of cameras is predetermined based on the size of the vehicle received in block 230. In some embodiments, the selection of the plurality of cameras is a subset of the plurality of cameras. In some embodiments, each of the plurality of cameras captures image data of the vehicle simultaneously. However, this is not required, and in some embodiments, the plurality of cameras capture image data of the vehicle at different times.

The method of imaging vehicles of different sizes is not limited to these three blocks 228, 230, 232, and in some embodiments, the method includes additional steps. For example, and in some embodiments, the method further includes moving the vehicle relative to the plurality of cameras. In some embodiments, the method further includes stopping the vehicle under the imaging system. For example, the vehicle is stopped under the imaging system such that the vehicle is still during the capturing step 232.

In some embodiments, initial image data of the vehicle is acquired via one or more of the cameras prior to the capturing step 232. This initial image data can be used to capture a license plate or other identifying information about the vehicle being imaged. The initial image data can also or alternatively be used by the processor to determine a size of the vehicle, such as in block 230 of the method.

Preferably, the method occurs quickly so that many vehicles can be imaged in an efficient manner. For example, and in some embodiments, the receiving step 230 and the capturing step 232 occur in less than five minutes, less than two minutes, less than one minute, less than thirty seconds, and/or less than fifteen seconds. In some embodiments, the method also includes one or more of the plurality of cameras tilting, panning, and/or zooming, such as to improve the quality of the image data captured.

In summary, the embodiments discussed above are useful for situations in which vehicles of a variety of different sizes are being imaged in a common location. For example, the placement and arrangement of the vehicle imaging system does not need to be rearranged whenever a differently sized vehicle is imaged. This allows multiple different vehicle types and sizes to be imaged quickly and efficiently with minimal manual labor required by operators of the imaging system.

These embodiments and obvious variations thereof are contemplated as falling within the spirit and scope of the claimed invention, which is set forth in the following claims. Moreover, the present concepts expressly include any and all combinations and sub combinations of the preceding elements and aspects.

What is claimed is:

1. An imaging system for imaging vehicles of different sizes, comprising:
a plurality of cameras located around a vehicle, each of the plurality of cameras being in a spaced apart relationship relative to adjacent ones of the plurality of cameras; and
a processor communicatively coupled to the plurality of cameras and configured to control which of the plurality of cameras acquire image data of the vehicle,
wherein, in response to a first vehicle of a first size being located below the plurality of cameras, the processor acquires first image data of the first vehicle from a first set of the plurality of cameras, and
wherein, in response to a second vehicle of a second size being located below the plurality of cameras, the processor acquires second image data of the second vehicle from a second set of the plurality of cameras, the first size being different from the second size, the first set of the plurality of cameras being different from the second set of the plurality of cameras.

2. The imaging system of claim 1, further comprising a plurality of rods extending downwardly from a structure located above the vehicle, each of the plurality of rods being arranged in a spaced-apart relationship relative to adjacent ones of the plurality of rods, wherein each of the plurality of cameras is coupled to a corresponding one of the plurality of rods.

3. The imaging system of claim 1, further including a lower camera configured to capture image data of an undercarriage of the vehicle.

4. The imaging system of claim 1, further including a movable front camera, the movable front camera configured to move relative to a front of the vehicle based on a size of the vehicle.

5. The imaging system of claim 4, further including a movable rear camera, the movable rear camera configured to move relative to a rear of the vehicle based on the size of the vehicle.

6. The imaging system of claim 5, wherein at least one of the movable front camera and the movable rear camera is capable of one or more of panning, tilting, and zooming.

7. A method of imaging vehicles with an imaging system having a plurality of cameras arranged in a spaced-apart relationship and a processor communicatively coupled to the plurality of cameras and configured to control which of the plurality of cameras acquire image data, the method comprising:
moving a first vehicle relative to the plurality of cameras;
acquiring, via at least one of the plurality of cameras, first initial image data of the first vehicle;
determining, via the processor, a first size of the first vehicle based on the first initial image data of the first vehicle;
capturing first image data of the first vehicle via a first set of the plurality of cameras, the first set of the plurality of cameras is based on the first size of the first vehicle;
after the first vehicle has moved away from the plurality of cameras, moving a second vehicle relative to the plurality of cameras;
acquiring, via at least one of the plurality of cameras, second initial image data of the second vehicle;
determining, via the processor, a second size of the second vehicle based on the second initial image data of the second vehicle; and
capturing second image data of the second vehicle via a second set of the plurality of cameras, the second set of the plurality of cameras is based on the second size of the second vehicle, wherein the first size is different from the second size and the first set of the plurality of cameras is different from the second set of the plurality of cameras.

8. The method of claim 7, wherein the first set of the plurality of cameras is predetermined based on whether the first size is within a first predetermined range; and the second set of the plurality of cameras is predetermined based on whether the second size is within a second predetermined range.

9. The method of claim 7, wherein the imaging system further comprises a plurality of rods extending downwardly from a structure located above at least one of the first vehicle and the second vehicle, each of the plurality of rods being arranged in a spaced-apart relationship relative to adjacent ones of the plurality of rods, wherein each of the plurality of cameras is coupled to a corresponding one of the plurality of rods.

10. The method of claim 7, wherein the first set of the plurality of cameras capture first image data of the first vehicle simultaneously.

11. The method of claim 7, wherein the determining and capturing occur in less than thirty seconds.

12. The method of claim 7, wherein the first vehicle is stopped under the imaging system while the first image data of the first vehicle is captured.

13. A method of imaging vehicles with an imaging system having a plurality of cameras arranged in a spaced-apart relationship and a processor communicatively coupled to the plurality of cameras and configured to control which of the plurality of cameras acquire image data, the method comprising:
moving a first vehicle relative to the plurality of cameras;
receiving, via the processor, a first size of the first vehicle from a user;
capturing first image data of the first vehicle via a first set of the plurality of cameras, the first set of the plurality of cameras is based on the first size of the first vehicle;
after the first vehicle has moved away from the plurality of cameras, moving a second vehicle relative to the plurality of cameras;
receiving, via the processor, a second size of the second vehicle from the user; and
capturing second image data of the second vehicle via a second set of the plurality of cameras, the second set of the plurality of cameras is based on the second size of the second vehicle, wherein the first size is different from the second size and the first set of the plurality of cameras is different from the second set of the plurality of cameras.

14. The method of claim 13, wherein the first size of the first vehicle from the user includes a number of tires on the first vehicle.

15. The method of claim 13, further including one or more of tilting, panning, and zooming at least one of the plurality of cameras.

16. The method of claim 13, wherein the first set of the plurality of cameras is a subset of the plurality of cameras.

17. The method of claim 13, wherein the vehicle is a boat, a motorcycle, or a trailer.

18. The method of claim 13, wherein the imaging system further comprises a plurality of rods extending downwardly from a structure located above at least one of the first vehicle and the second vehicle, each of the plurality of rods being arranged in a spaced-apart relationship relative to adjacent ones of the plurality of rods, wherein each of the plurality of cameras is coupled to a corresponding one of the plurality of rods.

19. The method of claim 13, further comprising:
moving at least one of a movable front camera and a movable rear camera of the plurality of cameras relative to the first vehicle based on the first size of the first vehicle.

20. The method of claim 13, wherein the first set of the plurality of cameras is predetermined based on whether the first size is within a first predetermined range and the second set of the plurality of cameras is predetermined based on whether the second size is within a second predetermined range.
